(19) United States
(12) Patent Application Publication
(10) Pub. No.: US 2015/0281631 A1
(43) Pub. Date: Oct. 1, 2015

(54) PROJECTION-TYPE VIDEO DISPLAY APPARATUS

(71) Applicant: HITACHI MAXWELL, LTD., Osaka (JP)

(72) Inventors: Hiroyuki Nakamura, Ibaraki (JP); Nobuyuki Kimura, Ibaraki (JP); Kohei Miyoshi, Ibaraki (JP)

(73) Assignee: HITACHI MAXELL, LTD., Osaka (JP)

(21) Appl. No.: 14/438,013

(22) PCT Filed: Nov. 7, 2012
(86) PCT No.: PCT/JP2012/078778

§ 371 Date: Apr. 23, 2015

(51) Int. Cl. H04N 5/74; G06T 3/40; G09G 5/02

(52) U.S. Cl. CPC H04N 5/7458; G09G 5/02; G06T 3/40

(57) ABSTRACT

A projection-type video display apparatus includes: a light source; an illumination optical system; a video display device; and a projection optical system, and the illumination optical system includes: a multireflection device which makes a distribution of light from the light source uniform; a color wheel which decomposes a color of light from the multireflection device; and a lens which enlarges light from the color wheel. When two orthogonal axes on a plane perpendicular to a traveling direction of the light are respectively defined as an X axis and a Y axis, a curvature radius of the lens in an X-axis direction differs from a curvature radius of the lens in a Y-axis direction. An aspect ratio of an emission surface of the multireflection device is larger than an aspect ratio of the video display device. The lens may be a cylindrical lens or a toroidal lens.

### TECHNICAL FIELD

The present invention relates to a projection-type video display apparatus.

### BACKGROUND ART

As a video display device of a projection-type video display apparatus which projects an image on a screen or the like, a DMD (Digital Micromirror Device: Texas Instruments Incorporated in US) has been known.

As a method for achieving a color display when using a single-plate DMD, a technique using a color wheel is disclosed (see Patent Document 1).

### RELATED ART DOCUMENTS

### Patent Documents

Patent Document 1: Japanese Patent Application Laid-Open Publication No. 2006-78949

### SUMMARY OF THE INVENTION

### Problems to be Solved by the Invention

According to Patent Document 1, in order to avoid color mixture, a portion which blocks light is provided on the color wheel. However, this blocks light for a long period of time, resulting in a large light loss.

Therefore, an object of the present invention is to provide a projection-type video display apparatus which reduces the light loss while suppressing color mixture.

### Means for Solving the Problems

In order to solve the above-mentioned problem, one of the preferred modes of the present invention is provided as follows. The projection-type video display apparatus includes: a light source; an illumination optical system; a video display device which modulates light from the light source in accordance with an external input signal; and a projection optical system which projects the light modulated by the video display device. The illumination optical system includes: a multireflection device which makes the distribution of light from the light source uniform; a color wheel which decomposes the color of light from the multireflection device; and a lens which enlarges the light from the color wheel. When two orthogonal axes on a plane perpendicular to a traveling direction of light are respectively defined as the X axis and the Y axis, a curvature radius of the lens in the X-axis direction differs from that in the Y-axis direction.

### Effects of the Invention

According to the present invention, it is possible to provide a projection-type video display apparatus which reduces the light loss while suppressing color mixture.

### BRIEF DESCRIPTIONS OF THE DRAWINGS

FIG. 1 is a configuration diagram showing the principal part of a projection-type video display apparatus according to an embodiment; and

FIG. 2 is a configuration diagram showing the principal part of a projection-type video display apparatus assumed to have a problem.

### DETAILED DESCRIPTION OF PREFERRED EMBODIMENTS

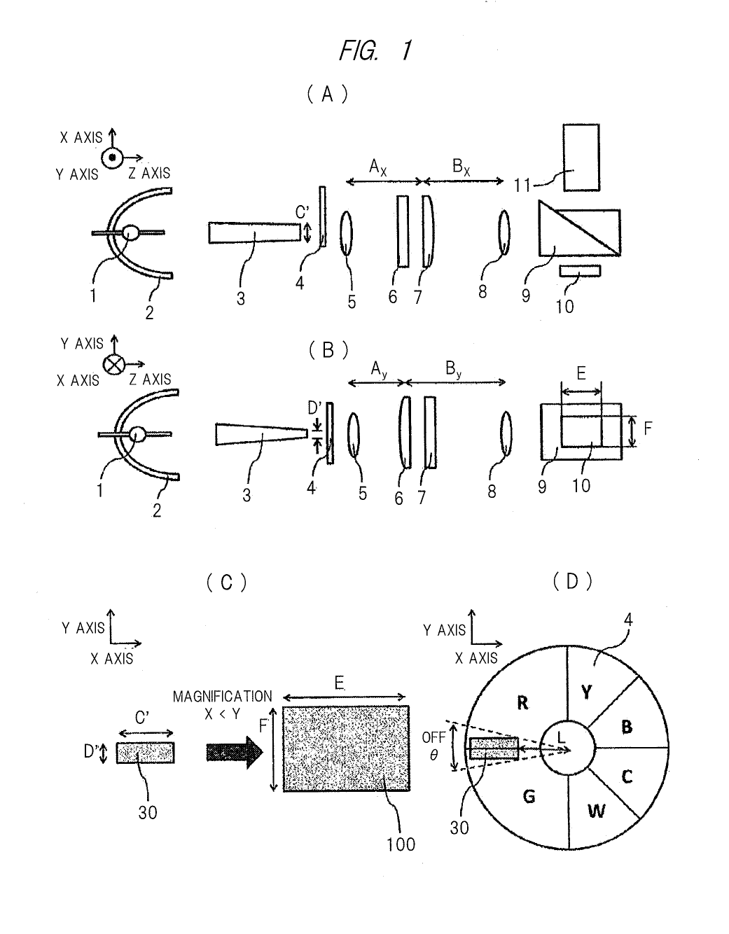

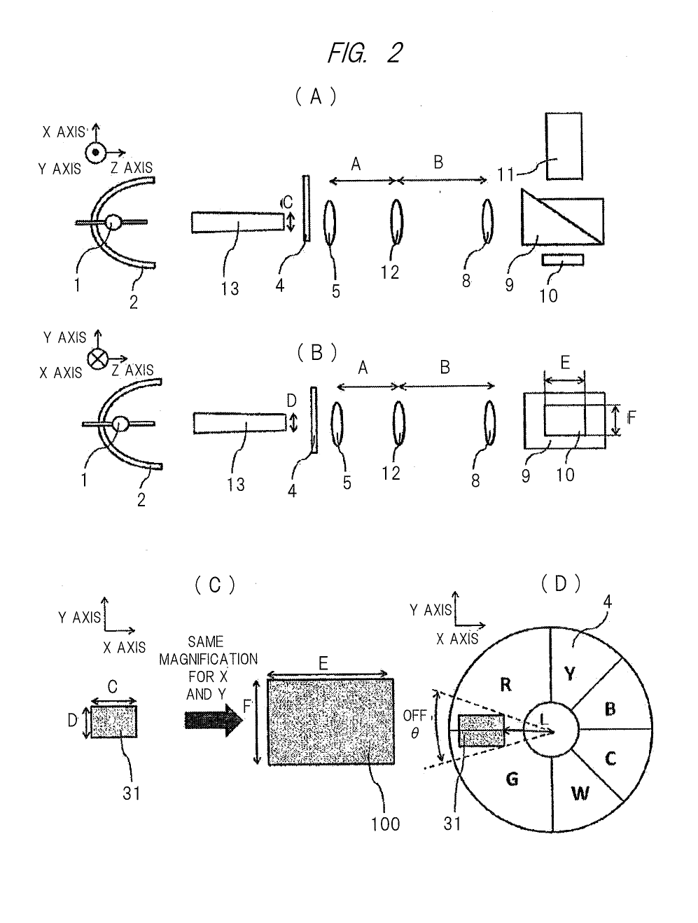

An embodiment will be described below with reference to the accompanying drawings. Note that the same components are denoted by the same reference characters throughout the accompanying drawings, and a repetitive description thereof will be omitted. In this case, a local right-handed orthogonal coordinate system is introduced. In FIG. 1(A) and FIG. 2(A), the longitudinal direction of a multireflection device (rod lens) is defined as the Z axis, the axis parallel to the drawing surface within a plane orthogonal to the Z axis is defined as the X axis, and the axis extending from the reverse side of the drawing surface to the obverse side is defined as the Y axis. In FIG. 1(B) and FIG. 2(B), the axis parallel to the drawing surface within a plane orthogonal to the Z axis is defined as the Y axis, and the axis extending from the obverse side of the drawing surface to the reverse side is defined as the X axis.

First, a problem to be solved by the present invention will be described. FIG. 2 is a configuration diagram showing the principal part of a projection-type video display apparatus assumed to have a problem. FIG. 2(A) is a top view showing the projection-type video display apparatus when viewed in the Y-axis direction, and FIG. 2(B) is a side view showing the projection-type video display apparatus when viewed in the X-axis direction.

In FIG. 2(A) and FIG. 2(B), the light emitted from a light source 1 is captured and condensed by a reflector 2 and enters a multireflection device 13. The multireflection device 13 is a quadrangular glass prism or a hollow device obtained by bonding four reflecting mirrors to each other.

The emission surface of the multireflection device 13 has a shape longer in the X-axis direction and shorter in the Y-axis direction, and the aspect ratio thereof is equal to that of a DMD 10. More specifically, when the length of the emission surface of the multireflection device 13 in the X-axis direction is defined as C, the length thereof in the Y-axis direction is defined as D, the length of the DMD 10 in the X-axis direction is defined as E, and the length thereof in the Y-axis direction is defined as F, C/D=E/F holds. Therefore, a light beam reflected a plurality of times within the multireflection device 13 has a light distribution which is similar to the DMD 10 and has a uniform intensity at the emission surface of the multireflection device 13.

A color wheel 4 is disposed near the emission surface of the multireflection device 13. The color wheel 4 is a rotation-controllable disk-shaped color filter in which six types of color filters which are respectively designed to transmit only the light beams of R (Red), G (Green), B (Blue), C (Cyan), Y (Yellow) and W (White) are sequentially arranged in the circumferential direction. Although it is possible to reproduce colors by using only three types of color filters of R (Red), G (Green) and B (Blue), color filters of six colors are generally used to improve the brightness.

As the color wheel 4 rotates, white light is temporally decomposed into six colors (R, G, B, C, Y and W). Light emitted from the multireflection device 13 is applied onto the DMD 10 through a relay lens 5, a relay lens 12, a relay lens 8 and a TIR prism 9.

The relay lens 5 prevents the divergence of light by condensing the light emitted from the multireflection device 13 to the relay lens 12. The relay lens 12 enlarges the light distribution, which has been made uniform on the emission surface of the multireflection device 13, onto the surface of the DMD 10. The relay lens 8 almost collimates the light from the relay lens 12. The TIR prism 9 totally reflects the incident light and guides it to the DMD 10.

The DMD 10 is a reflection-type light modulation device formed from a two-dimensional mirror array capable of controlling the tilt of respective micromirrors, and the tilt of the micromirrors takes two states, namely, the ON state and the OFF state. When the DMD 10 is irradiated with illumination light, the micromirror in the ON state reflects the illumination light (hereinafter, referred to as ON light) toward a projection lens 11, and the micromirror in the OFF state reflects the illumination light (hereinafter, referred to as OFF light) to the outside of the projection lens 11. More specifically, only the ON light is enlarged and projected on a screen or the like through the projection lens 11.

One micromirror corresponds to a minimum constituent element (pixel) of a projection image, and a pixel corresponding to a micromirror in the ON state is projected in white and a pixel corresponding to a micromirror in the OFF state is projected in black. Changing the duration of the ON state can provide tone. More specifically, video display is implemented by controlling the duration of the ON state of each micromirror.

The DMD 10 is synchronized with the color wheel 4 by a controller (not shown), and it displays an image based on an image signal for each color light from the color wheel 4 and also reflects the light entering from the TIR prism 9 toward the projection lens 11. Since the light beam reflected by the DMD 10 has an angle that does not satisfy the total reflection angle of the TIR prism 9, it is transmitted through the TIR prism 9 and enters the projection lens 11. Note that a system through which the light emitted from the light source 1 is reflected by the reflector 2 and is transmitted through the TIR prism 9 is referred to as an illumination optical system.

FIG. 2(C) is a diagram showing a light distribution 31 on the emission surface of the multireflection device 13 and a light distribution 100 on the surface of the DMD 10. When the relay lens 5 is disposed near the multireflection device 13, the magnification at which the light distribution 31 is enlarged into the light distribution 100 depends on the relay lens 12. When the distance between the relay lens 5 and the relay lens 12 is defined as A and the distance between the relay lens 12 and the relay lens 8 is defined as B, the enlargement magnification is given by B/A.

In general, the shape of the emission surface of the multireflection device 13 is almost similar to the effective range on the surface of the DMD 10, and a lens having the same curvature in the X-axis direction and the Y-axis direction is used as the relay lens 12. Therefore, the magnifications at which the light distribution 31 is enlarged into the light distribution 100 are B/A in both of the X-axis direction and the Y-axis direction.

FIG. 2(D) is a diagram showing the relationship between the color wheel 4 and a spoke time. Since the color wheel 4 is disposed near the multireflection device 13, the light distribution 31 on the emission surface of the multireflection device 13 is projected onto the color wheel 4 with almost no change. At the boundaries between the respective color filters of the color wheel 4 (FIG. 2(D) shows the boundary between R and G as an example), light is blocked (DMD 10 is in the OFF state) so as to avoid color mixture. The time during which light is blocked is referred to as the spoke time. In the spoke time, the emitted light is lost.

In order to minimize the spoke time, the color wheel 4 is disposed so that the boundaries between the respective color filters become parallel to the longitudinal direction of the light distribution. However, since the light distribution has a given width in the Y-axis direction, the spoke time inevitably increases to a certain extent, resulting in the light loss. As one applicable method for reducing the spoke time, the emission surface of the multireflection device 13 may be reduced while maintaining its aspect ratio. However, this increases the light condensation density and may lead to a deterioration in the glass or deposition film of the multireflection device 13. For this reason, the emission surface needs to have a size equal to or larger than a certain value.

Next, an embodiment will be described. FIG. 1 is a configuration diagram showing the principal part of a projection-type video display apparatus according to this embodiment, and FIG. 1(A) to FIG. 1(D) correspond to FIG. 2(A) to FIG. 2(D), respectively. The main differences between FIG. 1 and FIG. 2 will be described below.

(1) The aspect ratio of a multireflection device 3 is larger than that of a DMD 10. More specifically, when the length of the emission surface of the multireflection device 3 in the X-axis direction is defined as C′, the length thereof in the Y-axis direction is defined as D′, the length of the DMD 10 in the X-axis direction is defined as E, and the length thereof in the Y-axis direction is defined as F, C′/D′>E/F holds. In addition, if an area C′×D′ of the emission surface of the multireflection device 3 is set to be equal to or larger than an area C×D of the emission surface of the multireflection device 13 in FIG. 2, the light density on the emission surface of the multireflection device 3 becomes equal to or less than that in FIG. 2, and this prevents a deterioration in the glass or deposition film of the multireflection device 3. Thus, the light beam reflected a plurality of times within the multireflection device 3 is emitted at the emission surface of the multireflection device 3 at an aspect ratio larger than that of the DMD 10.

(2) A cylindrical lens 6 and a cylindrical lens 7 are disposed between the relay lens 5 and the relay lens 8. In order to prevent the divergence of the light emitted from the multireflection device 3, the relay lens 5 condenses the light to the cylindrical lens 6. The cylindrical lens 6 and the cylindrical lens 7 enlarge the light distribution, which has been made uniform on the emission surface of the multireflection device 3, in the X-axis direction and the Y-axis direction, respectively, onto the surface of the DMD 10, thereby setting the aspect ratio of the light distribution to the panel aspect ratio.

Each cylindrical lens in this case is a lens having a curvature only in one axis direction. The cylindrical lens 6 has a curvature only in the Y-axis direction and the cylindrical lens 7 has a curvature only in the X-axis direction. Therefore, the light diverging from the emission surface of the multireflection device 3 in the Y-axis direction is enlarged and applied onto the surface of the DMD 10 by the cylindrical lens 6, and the light diverging from the emission surface of the multireflection device 3 in the X-axis direction is enlarged and applied onto the surface of the DMD 10 by the cylindrical lens 7.

In the case where the relay lens 5 is disposed near the multireflection device 3, when the distance between the relay lens 5 and the cylindrical lens 7 is defined as Ax, the distance between the cylindrical lens 7 and the relay lens 8 is defined as Bx, the distance between the relay lens 5 and the cylindrical lens 6 is defined as Ay, and the distance between the cylindrical lens 6 and the relay lens 8 is defined as By, the magnifications at which a light distribution 30 on the emission surface of the multireflection device 3 is enlarged into a light distribution 100 on the surface of the DMD 10 in FIG. 1(C) are given by Bx/Ax in the X-axis direction and By/Ay in the Y-axis direction, respectively.

Since the cylindrical lens 6 is located closer to the multireflection device 3 than the cylindrical lens 7 is, Ax>Ay and Bx<By hold, and By/Ay is larger than Bx/Ax. In this case, when the aspect ratio of the emission surface of the multireflection device 3 is compared with that of the DMD 10, it is longer in the X-axis direction and shorter in the Y-axis direction. Therefore, by enlarging the light of the emission surface longer in the X-axis direction at the smaller magnification Bx/Ax and enlarging the light of the emission surface shorter in the Y-axis direction at the larger magnification By/Ay, the light distribution 100 on the surface of the DMD 10 is made to have a shape approximately similar to the DMD 10.

In FIG. 1(D), since the color wheel 4 is disposed near the multireflection device 3, the light distribution 30 on the emission surface of the multireflection device 3 is projected on the color wheel 4 with almost no change. When the light distribution 30 is located at the boundary between color filters of the color wheel 4, the DMD 10 is turned off and the light is lost. However, since the light distribution 30 is long in the X-axis direction and short in the Y-axis direction, it is possible to shorten the spoke time during which light is turned off and the light loss can be reduced.

If the amount of light loss in projectors can be reduced by 3%, the amount of luminous flux can be increased by about 100 lm and this makes it possible to upgrade the amount of luminous flux by one rank in projectors in the 3000 lm class or higher which are in the volume zone. Thus, the aspect ratio of the emission surface of the multireflection device for reducing the amount of light loss caused by the spoke time by 3% will be described with reference to FIG. 2.

When the number of segments of the color wheel is defined as a and an off angle is defined as θ, the amount of light loss d due to the spoke time is represented by equation (1):

d=(a×θ)÷360 (1)

For example, when the number of segments a of the color wheel is 6 and the off angle θ is a general angle of 10°, the amount of light loss d is 16.7%. Thus, in order to reduce the amount of light loss by about 3% to 13.7%, it is necessary to decrease the off angle from 10° in FIG. 2 to 8.2° or less.

When the off angle in FIG. 2 is defined as θ, the off angle in FIG. 1 is defined as θ′, and the shortest distance from the center of the color wheel 4 to the light distribution 30 and the light distribution 31 in FIG. 1 and FIG. 2 is defined as L, the length D of the light distribution 31 in the Y-axis direction and the length D′ of the light distribution 30 in the Y-axis direction are respectively represented by equations (2) and (3):

D=2L×tan(θ/2) (2)

D′=2L×tan(θ′/2) (3)

In addition, when the light distribution 30 and the light distribution 31 are made to have the same area in order to prevent a reduction in the service life of the multireflection device 3, equation (4) holds:

C×D=C′×D′ (4)

In FIG. 2, since the light distribution 31 is similar to the light distribution 100, equation (5) holds:

C/D=E/F (5)

An aspect ratio C′/D′ of the emission surface of the multireflection device 3 in FIG. 1 is represented by equation (6) by using equations (2) to (5):

C′/D′=(E/F)×[tan(θ/2)÷tan(θ′/2)]×[tan(θ/2)÷tan(θ′/2)] (6)

The resolution of the DMD is, for example, XGA (1024×768), WXGA (1280×800) or 1080P (1920×1080), and the aspect ratio is, 4/3, 16/10, or 16/9, respectively. The aspect ratios of DMD are mainly classified into these three types. Thus, when the aspect ratio of the DMD is 4/3, 16/10, or 16/9, the aspect ratio C′/D′ of the emission surface of the multireflection device 3 is calculated as 1.99, 2.38, or 2.65. Therefore, when the aspect ratio of the DMD is 4/3, 16/10, or 16/9, the aspect ratio C′/D′ shall be set to 1.99 or more, 2.38 or more, or 2.65 or more, respectively.

According to this embodiment, it is possible to increase the color luminance of a projection image while reducing the loss of irradiation light by shorting the spoke time while maintaining the effect of suppressing the color mixture.

Although two cylindrical lenses are used in this embodiment, a single cylindrical lens which is orthogonal in incident and emission angles may be used. In addition, although cylindrical lens having one axis as a plane on one surface is used in this embodiment, a toroidal lens having different curvatures in the X-axis direction and the Y-axis direction on one surface may be used.

### DESCRIPTION OF REFERENCE CHARACTERS

1 . . . light source, 2 . . . reflector, 3, 13 . . . multireflection device, 4 . . . color wheel, 5, 8, 12 . . . relay lens, 6, 7 . . . cylindrical lens, 9 . . . TIR prism, 10 . . . DMD, 11 . . . projection lens, 30, 31, 100 . . . light distribution

1. A projection-type video display apparatus comprising:
a light source;
an illumination optical system;
a video display device which modulates light from the light source in accordance with an external input signal; and
a projection optical system which projects the light modulated by the video display device,
wherein the illumination optical system includes:
a multireflection device which makes a distribution of light from the light source uniform;
a color wheel which decomposes a color of light from the multireflection device; and
a lens which enlarges light from the color wheel,
an aspect ratio of an emission surface of the multireflection device is larger than an aspect ratio of the video display device, and
when two orthogonal axes on a plane perpendicular to a traveling direction of the light are respectively defined as an X axis and a Y axis, a curvature radius of the lens in an X-axis direction differs from a curvature radius of the lens in a Y-axis direction.

2. The projection-type video display apparatus according to claim 1,
wherein the aspect ratio of the emission surface of the multireflection device is not less than 1.99 when the aspect ratio of the video display device is 4/3, it is not less than 2.38 when the aspect ratio of the video display device is 16/10, and it is not less than 2.65 when the aspect ratio of the video display device is 16/9.

3. The projection-type video display apparatus according to claim 1,
wherein the lens is a cylindrical lens or a toroidal lens.

4. A projection-type video display apparatus comprising:
a light source;
an illumination optical system;
a video display device which modulates light from the light source in accordance with an external input signal; and
a projection optical system which projects the light modulated by the video display device,
wherein the illumination optical system includes:
a multireflection device which makes a distribution of light from the light source uniform;
a color wheel which decomposes a color of light from the multireflection device; and
a lens which enlarges light from the color wheel,
when two orthogonal axes on a plane perpendicular to a traveling direction of the light are respectively defined as an X axis and a Y axis, a curvature radius of the lens in an X-axis direction differs from a curvature radius of the lens in a Y-axis direction, and
an aspect ratio of an emission surface of the multireflection device is not less than 1.99 when an aspect ratio of the video display device is 4/3, it is not less than 2.38 when the aspect ratio of the video display device is 16/10, and it is not less than 2.65 when the aspect ratio of the video display device is 16/9.

5. The projection-type video display apparatus according to claim 4,
wherein the lens is a cylindrical lens or a toroidal lens or a toroidal lens.

6. (canceled)
